(19) United States
(12) Patent Application Publication
(10) Pub. No.: US 2010/0025143 A1
(43) Pub. Date: Feb. 4, 2010

(54) SYSTEM IN A VEHICLE AND A HEAVY VEHICLE

(75) Inventors: Mikael Gustavsson, Skene (SE); John Henström, Alingsas (SE); Tomas Andreason, Göteborg (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/306,698

(22) PCT Filed: Jun. 26, 2007
(86) PCT No.: PCT/SE2007/000617

§ 371 Date: Aug. 12, 2009

(30) Foreign Application Priority Data
Jun. 28, 2006 (SE) 0601430-2

(51) Int. Cl. B60K 5/00

(52) U.S. Cl. 180/292

(57) ABSTRACT

A heavy vehicle includes a drive unit arranged substantially along a longitudinal geometrical axis of the vehicle. The drive unit is inclined by being pivoted about an axis whereby the drive unit forms an angle relative to the longitudinal geometrical axis. The pivot axis is situated in an intersectional point between the longitudinal geometrical axis and a longitudinal center axis of the drive unit, and the intersectional point is situated in a position within the extension of the drive unit.

### BACKGROUND AND SUMMARY

The present invention relates to a system in a vehicle, and a heavy vehicle comprising a drive unit arranged substantially along a longitudinal geometrical axis of the vehicle.

A heavy vehicle, such as a truck or a bus, comprises a power transmission system or in other words a drive line for transferring power from an engine to driving wheels of the vehicle. Usually, the drive line comprises a drive unit, i.e. an engine and a gear box, and a propeller shaft and a differential. The drive line is a well balanced optimized system in order to provide power in a safe manner and with low vibrations transferred to the vehicle.

A truck is often heavy and large, for example weighing several thousand kilograms and has a powerful engine for driving the wheels. During certain unfavorable conditions the high power output transferred by the driveline may cause undesired vibrations of the drive line. Drive line vibration problems may arise when the drive line is assembled with components having dimensions which are in the outer ranges of the component tolerances allowed.

In many trucks the connecting point between the propeller shaft and the differential is laterally displaced relative to a longitudinal geometrical axis of the vehicle, whereas the connecting point between the drive unit and the propeller shaft is situated on the longitudinal geometrical axis. Thus, the propeller shaft arranged between the drive unit and the differential is usually inclined. Due to the inclination of the propeller shaft vibrations may arise. Furthermore, for different length legislations on different markets, for instance, it is desired to decrease the wheel base of heavy vehicles which in turn may increase the vibration problems due to the fact that the inclination angle of the propeller shaft is increased when using a shorter wheel base together with a given differential offset.

It is desirable to provide a system which is able to counteract or decrease drive line vibrations in a vehicle.

According to a first aspect of the invention a system in a vehicle comprising an engine and a gearbox connectable to an output end of said engine arranged along a center axis in the vehicle's longitudinal direction is provided. The engine and\or gearbox is rotated about their vertical axis in a horizontal plane deviating in an angle from said center axis. The longitudinal direction is in a movement direction of the vehicle.

The system may further comprise a spacer arranged in at least one mounting position of said engine or gearbox for achieving said vertical rotation. In one embodiment the system may comprise a thinner engine cushion arranged in at least one mounting position of said engine or gearbox for achieving said vertical rotation. The system may also comprise a thicker engine cushion arranged in at least one mounting position of said engine or gearbox for achieving said vertical rotation. The system may also comprise an engine support arranged in at least one mounting position of said engine or gearbox for achieving said vertical rotation and where said engine support is arranged with an oblong receiving structure for fastening said engine support to said engine or said gearbox.

Preferably, the vertical rotation of said engine and/or gearbox is in the range from 0.05 to 1.2 degree.

According to a second aspect of the invention, an engine support for use in mounting an engine and/or gearbox is provided. The engine support is equipped with an oblong receiving structure for mounting said engine or gearbox in a position variable horizontal plane and in a substantially perpendicular direction to an axis substantially parallel with said vehicles longitudinal direction.

The invention also relates to a method for accommodating an alignment difference between components of a power transmission system due to a shortened distance between said power transmission system components, said method comprising a step of: adjusting a position of an engine and/or gearbox rotated vertically in a horizontal plane in order to accommodate an alignment difference with respect to an axis along a longitudinal direction of said vehicle in said horizontal plane between said engine and/or gearbox with a differential. The method may further comprise a step of mounting a spacer in at least one mounting position of the engine or gearbox for tilting said engine or gearbox around a tilting axis.

An advantage of the present invention is that it can accommodate alignment differences between the engine and differential or that it can provide a possibility to reduce the distance between the engine and the differential without major redesign of the vehicle geometry.

These and other aspects of the invention will be apparent from and elucidated with reference to the embodiments described hereinafter.

It is also desirable to provide a heavy vehicle, in which vehicle drive line vibrations is counteracted or decreased relative to corresponding prior art heavy vehicles.

By the provision of a drive unit which is inclined by being pivoted about an axis whereby the drive unit forms an angle relative to the longitudinal geometrical axis, wherein the pivot axis is situated in a intersectional point between the longitudinal geometrical axis and a longitudinal center axis of the drive unit, and the intersectional point is situated in a position within the extension of the drive unit, it has surprisingly been proved in tests that a relatively small inclination of the drive unit can contribute to important benefits with respect to power transmission and decreased drive line vibrations.

Inclination angles in the size of 1° can decrease the vibrations to a substantial extent. The inclination angle is preferably in the interval from 0.05 to 1.5 degrees, and more preferably in the interval from 0.25 to 1.2 degrees.

The pivot axis is preferably substantially vertical so as to incline the drive unit in a substantially horizontal plane. The invention is particularly useful in a vehicle which comprises a propeller shaft connected to the drive unit, wherein the drive unit is inclined so as to compensate for an inclination of the propeller shaft relative to the longitudinal geometrical axis, since the propeller shaft extending between the drive unit and a differential often has a connecting position to the differential which position is arranged with an lateral offset relative to the longitudinal geometrical axis, and a lateral offset relative to the connecting point between the drive unit and the propeller shaft.

The concept of the invention can be used when producing new heavy vehicles, but also vehicles which already exit on the market can easily get the drive unit adjusted in accordance with the present invention. Such an inclination adjustment of the drive unit can be provided as a service solution so as to decrease drive line vibrations of older vehicles. The invention also relates to a method which can be used when performing service and maintenance of a heavy vehicle.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a power transmission according to the present invention;

FIG. 2 illustrates a power transmission of FIG. 1 in more detail;

FIG. 3 illustrates a perspective view of a part of a mounting system for the power transmission according to another embodiment of the present invention;

FIG. 4 illustrates schematically a power transmission system according to another embodiment of the present invention;

FIG. 5 illustrates schematically another embodiment of the present invention; and

FIG. 6 is a schematic plan view of a heavy vehicle according to the invention.

### DETAILED DESCRIPTION

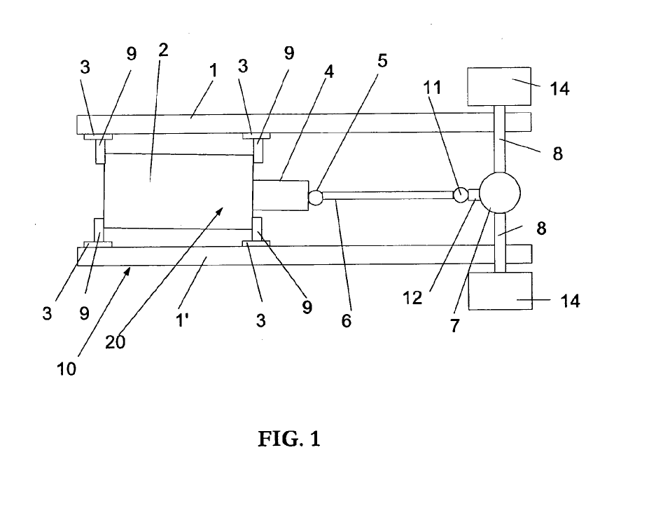

In FIG. 1, the reference numeral 10 generally denotes a frame of a commercial vehicle. The frame 10 is composed of two U-profile longitudinal side members 1, 1′ united by a plurality of cross members (not shown). An engine 2 is mounted together with a gear box 4 on the frame 1 and 1′ by engine supports each comprising an engine bearer 9 and engine cushion 3. The engine and gearbox together form an engine/gearbox assembly 20. A universal joint 5 is mounted on the gearbox 4 and a propeller shaft 6 transmits power from the engine/gearbox assembly 20 to a differential 7 via a second universal joint 11. The differential 7 distributes the engine power to each driving wheel 14 via respective drive shafts 8. The engine 2, gearbox 4, propeller shaft 6, universal joints 5, 11, and differential 7 together form a power generating and transmission system. Other parts may be used in relation to the power transmission system, for instance a propeller shaft 6 bearing (not shown) for guiding the propeller shaft 6 can be used. Connections between the different components can be of any suitable type as understood by the person skilled in the art, for instance a spliced shaft fitting into a spliced receiving member (not shown), this type of connection has the benefit of allowing axial movement of the components relative each other. Reference number 12 indicates an input pinion of the differential 7 for inputting the power into the differential 7. Other ways of connecting the propeller shaft 6 with the gearbox 4 and/or differential directly or indirectly via universal joints 5, 11 may be used, for instance applying a carry-over (not shown) in conjunction with the universal joints 5, 11 or at least one of the universal joints 5, 11 may be replaced by a joint (not shown) on the propeller shaft 6 itself dividing the propeller shaft 6 into two parts.

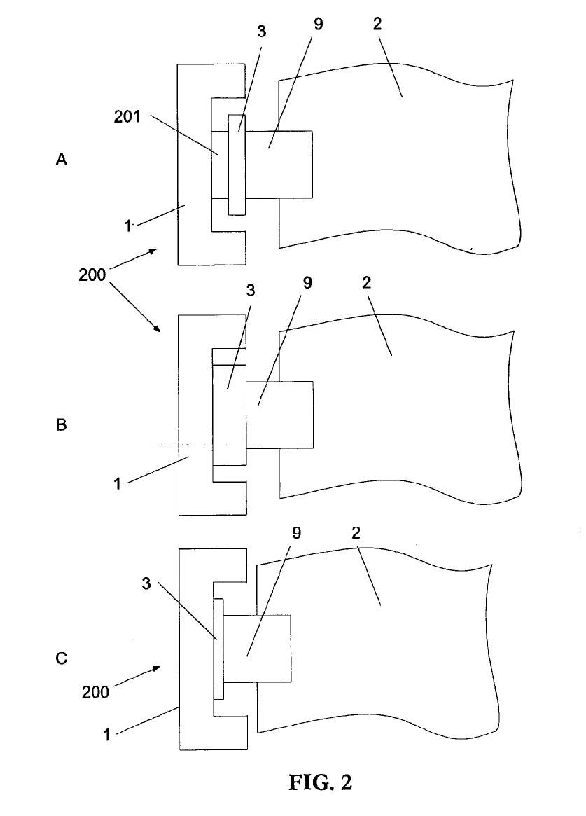

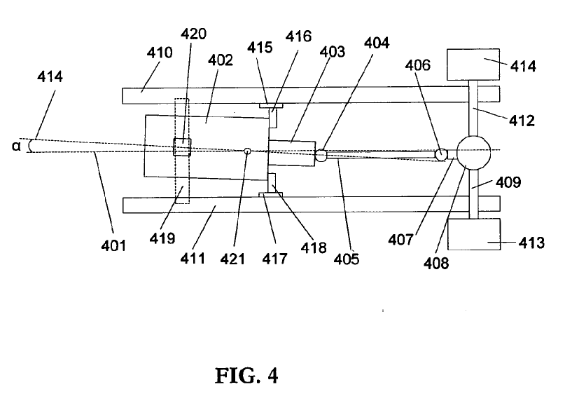

Turning now to Hg. 2, which illustrates different embodiments of the present invention for mounting the engine/gearbox assembly 20 to the frame, wherein the same reference numerals designate same parts as in FIG. 1. FIG. 2 illustrates different variations on how the assembly parts may be combined according to the present invention. The engine 2 is mounted on the frame side member 1 using a plurality of engine bearers 9 and these in turn may be mounted with engine cushions 3 to the side members 1 of the frame 10. The engine cushions 3 provide dampening of vibrations from the engine 2 to the frame side member 1. In one embodiment of the present invention the engine 2 and gearbox 4 are mounted with two engine bearers 3 at a rear end on each longitudinal side and one engine bearer on a top side of the engine 2; this situation is illustrated in FIG. 4 in more detail. Other embodiments include for instance engine bearers on rear end and front end of the longitudinal sides of the engine 2. The engine cushions may be mounted to the frame using for instance fastening means like a screw, bolt and nut, or rivet; however, the fastening means are not shown since they are understood by the person skilled in the art. FIGS. 2A to C illustrate a rear view of one of the rearward engine mounting positions, i.e. with a cross section through the frame side member 1, the engine cushion 3, the engine bearer 9, and engine 2 (or engine gearbox assembly 20). Only part of the engine 2 is shown in FIGS. 2A to C.

The purpose of the present invention is to provide a solution for accommodating alignment differences, obtained when decreasing the wheel base of the vehicle, in the power transmission system with a low cost and without adding any substantial weight to the vehicle. In many vehicles the output from the gearbox is not perfectly aligned with an input pinion of the differential since often the input shaft of the differential is aligned off center from the center axis of the vehicle along the longitudinal direction of the vehicle whereas the output shaft from the gearbox is often aligned in the center axis of the vehicle. For this purpose universal joints are provided in order to accommodate some alignment differences. However, these universal joints can only accommodate a certain amount of alignment difference and another solution is required. This is the case if the distance between the engine/gearbox and differential is reduced, then the possibility for the joints to accommodate the difference is reduced. This can be solved by adding an additional joint at some suitable point on the propeller shaft 6. However, this will increase weight considerably and add cost in manufacturing of the vehicle. The present invention provides a simple but yet ingenious and cost effective solution by tilting the engine/gearbox in relation to a center axis extending in a longitudinal direction of the vehicle and in a plane substantially parallel to the ground. The tilting of the engine/gearbox assembly may be done by adjusting the lateral position of the engine/gearbox assembly at one or several engine bearer positions. Adjustments of the order 5 to 10 mm can easily be accommodated and is efficient for enabling a reduction of the propeller shaft length without requiring any other significant redesigns of the vehicle in the engine compartment or of the engine mounting parts. FIG. 2A illustrates a first case of how to adjust the position of the engine/gearbox assembly 20 laterally by introducing a spacer 201 between the frame side member 1 and the engine cushion 3, thus providing an increased distance between the engine 2 and one of the side members which in turn provides an angular shift with respect to the center axis of the vehicle. FIG. 2B illustrates another embodiment of the present invention where the engine cushion is provided with a thickness that will increase the distance between the frame side member 1 and the engine 2. FIG. 2C illustrates yet another embodiment of the present invention where the engine cushion is provided with a thickness that reduces the distance between the frame side member 1 and the engine 2 thus providing a shift in the opposite direction as compared to the cases in FIGS. 2A and B.

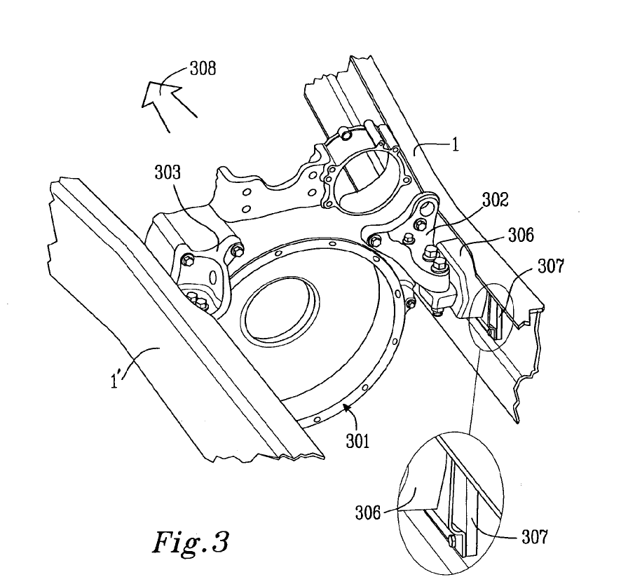

FIG. 3 shows a more detailed perspective view of the rear end of the engine. A fly wheel casing 301 part of the engine is mounted to two engine bearers 302, 303 located in a rearward direction of the fly wheel casing. The engine bearers 302, 303 may in turn each be mounted on an engine cushion 306 (only one is visible in FIG. 3) mounted to each frame side member 1, 1′. In FIG. 3 the engine cushions are mounted within the U of the U-profile of the frame side members 1, 1′; however, it should be understood that they may alternatively be mounted in any other suitable position, e.g. on the top or bottom part of the side member. A spacer 307 can be applied between one of the engine cushions 306 and side frames 1, thus providing the shift in the horizontal plane to accommodate a reduction of the propeller shaft length. Arrow 308 indicates the forward direction of the vehicle.

Turning now to FIG. 4 illustrating another embodiment and with geometrical considerations of the present invention, the amount of tilting (rotation around vertical axis 421 which is substantially perpendicular to the plane of the paper) needed depends on the distance between engine/gearbox assembly 430 and the differential 408 and the amount of alignment difference between the differential and the engine/gearbox assembly. The power transmission system similar as shown in FIG. 1 with an engine 402, a gearbox 403 positioned at rearward position from the engine 402, a first universal joint 404 mounted on a output end of the gearbox 403 and a propeller shaft 405 transmitting power from the gearbox 403 and the first universal joint 404 to a second universal joint 406. The second universal joint 406 is mounted on an input pinion 407 on a differential 408 which in turn transmits the power to drive lines 409, 412 to each driving wheel 413. A simple solution for applying tilting of the engine is to introduce a spacer (not shown) between the side member 410, 411 of the frame and the engine cushion 415, 417 on one side of the engine and thereby shifting the engine an amount away from a central axis 401. In the embodiment illustrated in FIG. 4, the engine is supported with two rearward side engine bearers 416, 418 and one top engine bearer 420 at a forward position of the engine. The top engine bearer 420 is supported on a cross member 419 mounted to each frame side member 410, 411. This cross member 419 may also be part of a system for stabilizing the frame 425. Introducing the spacer at one of the rearward side mounting positions, the engine will tilt around a rotational axis centered on the forward top bracket, the central axis 414 extending through the engine/gearbox assembly 430 is shown in FIG. 4 and an angle a from the central axis is indicated. The spacer dimensions will vary depending on the type of engine cushion and the amount of tilting needed. This is a simple solution which easily can accommodate a wide range of different tilting angles a and which is very cost effective and easy to mount during installation of the power transmission system. The angle that can be adjusted ranges from 0 to 1.2 degree with this method without changing any other details, which may accommodate alignment differences of the order up to 120 mm between the engine/gearbox output central axis and the differential input central axis. The engine and/or the gearbox may be mounted in other ways than what is indicated above, for instance in some installations a separate front axel beam may be used for also mounting the engine and/or gearbox, this type of mounting is often used for instance in cars.

Another solution is to use a thinner engine cushion on one side of the rearward mounting positions as compared to the other side and thus tilting the engine in this direction. Another solution for the engine cushion is to redesign the engine cushion to be larger or for instance the holes for mounting the engine bearer 416, 418 to the engine/gearbox assembly 430 may be arranged so as to provide the tilting movement in the lateral plane of the engine/gearbox assembly 20 in a suitable direction. With this arrangement engine/gearbox assemblies need no redesign to be used in the present invention, it is even possible to retrofit vehicles with these components. If the engine bearer is equipped with oblong holes for the fasteners (e.g. a screw or bolt and nut) it is possible to adjust the position infinitely variable and thus optimize the tilting position for each installation case.

A combination of spacer, adjusted size of engine cushion and redesigned engine bearer can be applied, for instance an engine cushion with a 5 mm increase in thickness can be combined with an engine bearer with 5 mm lateral adjustment of the position thus a combined 10 mm lateral adjustment can be achieved.

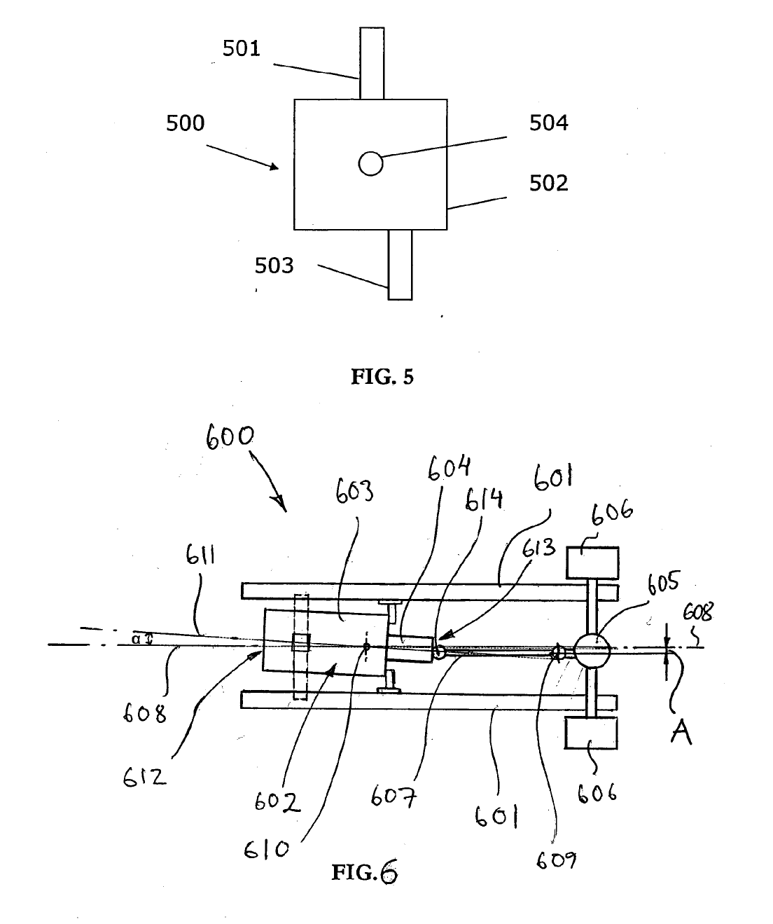

In yet another embodiment is found in a variation of the engine cushion 500 as illustrated in FIG. 5, where the engine cushion 502 has an arrangement for receiving two fasteners 501, 503, such as pins, bolts or similar devices not aligned with each other with respect to a longitudinal direction of the fasteners and not centered on the engine cushion 500. The engine cushion 500 may then be used for two purposes: in one mounting position, the engine cushion may provide an offset from the center axis of part of the engine (i.e. a tilting angle in the horizontal plane) when mounting the engine and in a second mounting 35 position turning the engine cushion 500 180 degrees the engine cushion 500 will act as a “normal” engine cushion not providing any tilting angle of the engine since the engine cushion 500 according to this embodiment is not rotational symmetric around an axis indicated with reference numeral 504.

The engine bearers may be mounted to either the engine or the gearbox depending on where receiving structures for the engine bearer are located, which is dependent on design, make and type of engine/gearbox assembly.

In another embodiment, the engine has more than three mounting positions, e.g. four mounting positions, two rearward and two forward positions. In this type of mounting arrangement in order to provide the same type of tilting a spacer or thinner engine cushion may be applied to the rearward position on one side and/or with a respective spacer of thinner engine cushion on the opposing forward mounting position: i.e. for instance if a spacer is mounted on the rearward left mounting position a similar spacer may be mounted on the forward right mounting position or with a spacer on the rearward left mounting position a thinner engine cushion can be mounted on the left forward position.

In an alternative embodiment of the present invention, the engine can be parallel translated in a direction compensating for the alignment difference; however, this may have problems arising from center of gravity changes invoking for instance vibrations and/or changing the behavior of the vehicle on the road. It is sometimes also difficult to position the engine in such a manner due to the constraint installation volume in the engine compartment and thus difficult to obtain without considerable redesign of the engine compartment.

The vehicles normal forward traveling direction has defined the forward direction of the vehicle in this document. This definition defines the relative positions of objects in the present invention as understood by the person skilled in the art.

FIG. 6 is a schematic plan view of a vehicle 600 according to the invention. The vehicle 600 may comprise two longitudinal frame beams 601. In the illustrated embodiment the vehicle comprises a drive unit 602 which is installed in the frame. The drive unit 602 comprises an engine 603 and a gear box 604. A differential 605 for transferring power to the wheels 606 is also schematically shown in FIG. 6. A propeller shaft 607 is connected at one end thereof to the drive unit 602 and at the other end thereof to the differential 605. The differential 605 is laterally displaced relative to the longitudinal center line 608 of the vehicle and relative to the drive unit 602. In other words; the connection point 609 between the propeller shaft 607 and the differential 605 is arranged offset relative to a longitudinal center line 608 of the vehicle 600. The offset is schematically illustrated by the distance A.

In case the drive unit would have been conventionally arranged rectilinearly along the longitudinally geometrical axis 608 an unfavorable inclination of the propeller shaft could have been the result. In accordance with the invention the drive unit 602 is inclined by being pivoted about an axis 610 (directed perpendicularly to the paper plane in FIG. 6) whereby the drive unit 602 forms an angle a relative to the longitudinal geometrical axis 608. The pivot axis 610 is situated in an intersectional point 610 between the longitudinal geometrical axis 608 and a longitudinal center axis 611 of the drive unit 602, and the intersectional point 610 is situated in a position within the extension of the drive unit 602. This implies the intersection point 610 is situated in a position between the front end 612 of the drive unit 602 and the rear end 613 of the drive unit 602. Hereby the inclination of the propeller shaft 607 is decreased, since the connecting point 614 between the drive unit 602 and the propeller shaft 607 is displaced in the same direction as the connecting point 609 between the propeller shaft 607 and the differential 605 is displaced.

In the illustrated embodiment of the invention the pivot axis 610 is substantially vertical which implies that the drive unit 602 is pivoted in a substantially horizontal plane so as to compensate for an inclination of the propeller shaft 607. The inclination angle a of the drive unit 602 relative to the longitudinal geometrical 608 axis is preferably in the interval from 0.05 to 1.5 degrees. It should be stressed that the heavy vehicle according to the invention can comprise one or more features of the system previously described herein and illustrated in FIGS. 1-5.

As previously described the invention also relates to a method for decreasing drive line vibration of a vehicle comprising inclining the drive unit 602 by pivoting the drive unit about an axis 610 whereby the drive unit 602 forms an angle a relative to a longitudinal geometrical axis 608, and wherein said pivot axis 610 is situated in a intersectional point 610 between the longitudinal geometrical axis 608 and a longitudinal center axis 611 of the drive unit 602, and the intersectional point 610 is situated in a position within the extension of the drive unit 602. It should be stressed that all features disclosed in the context of the system and the vehicle, particularly illustrated in FIG. 6, can be applied together with the method according to the invention.

It is to be understood that the present invention is not limited to the embodiments described above and illustrated in the drawings; rather, the skilled person will recognize that many changes and modifications may be made within the scope of the appended claims.

1. A system in a vehicle comprising an engine and a gearbox connectable to an output end of the engine arranged along a center center axis in a longitudinal direction of the vehicle, the engine and gearbox being arranged to transmit power to a differential via a propeller shaft and mounted to a frame of the vehicle with a plurality of mounting positions, wherein the engine and gearbox are rotated about a vertical axis in a horizontal plane and form an angle with the center center axis, the vertical axis being situated in an intersectional point between the center center axis and a longitudinal center center axis of the engine and gearbox, which intersectional point is situated in a position within the extension of the engine and gearbox

2. The system of claim 1, wherein the longitudinal direction is in a movement direction of the vehicle

3. The system according to claim 1, comprising a spacer arranged in at least one of the mounting positions of the engine or gearbox for achieving the vertical rotation

4. The system according to claim 1, comprising an engine cushion, with different thickness than the other engine cushions used for holding the engine and/or gearbox, arranged at one mounting position of the engine or gearbox for achieving the vertical rotation

5. The system according to claim 1, comprising an engine support arranged in at least one mounting position of the engine or gearbox for achieving the vertical rotation and where the engine support is arranged with an oblong receiving structure for fastening the engine support to the engine or the gearbox

6. The system according to claim 1, wherein the vertical rotation of the engine and/or gearbox is in the range from 0.05 to 1.2 degree

7. A method for accommodating an alignment difference between components of a power transmission system due to a shortened distance between the power transmission system components, the method comprising:
adjusting a position of an engine and/or gearbox rotated vertically in a horizontal plane in order to accommodate an alignment difference with respect to an axis along a longitudinal direction of the vehicle in the horizontal plane between the engine and/or gearbox with a differential

8. The method according to claim 7, further comprising mounting a spacer in at least one mounting position of the engine or gearbox for tilting the engine or gearbox around a tilting axis

9. A vehicle comprising a system according claim 1.

10. A heavy vehicle comprising a drive unit arranged substantially along a longitudinal geometrical axis of the vehicle,
wherein the drive unit is inclined by being pivoted about an axis whereby the drive unit forms an angle relative to the longitudinal geometrical axis, the pivot axis being situated in an intersectional point between the longitudinal geometrical axis and a longitudinal center center axis of the drive unit, the intersectional point being situated in a position within the extension of the drive unit

11. Vehicle according to claim 10, wherein the pivot axis is substantially vertical

12. Vehicle according to claim 10, wherein the vehicle comprises a propeller shaft connected to the drive unit, the drive unit being inclined so as to compensate for an inclination of the propeller shaft relative to the longitudinal geometrical axis

13. Vehicle according to claim 12, wherein the propeller shaft extending between the drive unit and a differential, the connecting position between the propeller shaft and the differential being arranged with an offset relative to the longitudinal geometrical axis

14. Vehicle according to claim 10, wherein the inclination angle of the drive unit is in the interval from 0.05 to 1.5 degrees

15. Vehicle according to claim 10, wherein the inclination angle of the drive unit is in the interval from 0.25 to 1.2 degrees

16. A method for decreasing drive line vibrations of a heavy vehicle, comprising
inclining the drive unit by pivoting the drive unit about an axis whereby the drive unit forms an angle relative to a longitudinal geometrical axis the pivot axis being situated in a intersectional point between the longitudinal geometrical axis and a longitudinal center center axis of the drive unit, the intersectional point being situated in a position within the extension of the drive unit

17. A method according to claim 16, comprising pivoting the drive unit about a substantially vertical axis.
